(19) United States
(12) Patent Application Publication
(10) Pub. No.: US 2011/0171598 A1
(43) Pub. Date: Jul. 14, 2011

(54) FALSE TEETH POSITIONING DEVICE

(76) Inventor: I ROOU WANG, Hsinchu City (TW)

(21) Appl. No.: 12/685,671

(22) Filed: Jan. 11, 2010

(51) Int. Cl. A61C 8/00

(52) U.S. Cl. 433/173

(57) ABSTRACT

A false teeth positioning device being embedded in the false teeth to attach the false teeth onto guns and comprising: a base including a concave surface to be attached onto the gums, the concave surface including a cavity formed thereon, the base including a hole fixed on one side surface thereof; a flexible attaching piece coupled to the concave surface to cover the cavity and including plural indentions arranged on a bottom surface thereof and plural flexible films formed on a top surface thereof to correspond to the indentions; an axial seat secured to one side of the base and including an axial bore disposed thereon to communicate with the cavity; a shaft fixed to the axial bore and including an O-shaped rubber ring arranged on an outer periphery of one end thereof proximate to the cavity; a driving member driven from an exterior to actuate the shaft to move.

### BACKGROUND OF THE INVENTION

1. Field of the Invention

The present invention relates to a false teeth positioning device which allows to attract the false teeth to the gums securely.

2. Description of the Prior Art

Conventional false teeth positioning method includes planting a metal piece to remained true teeth, and then a magnetic block is embedded to a position relative to the false teeth, however such positioning method will case the false teeth insecure or falling, and the remained true teeth have to be drilled to form a hole to embed the metal piece, having a complex installation.

The present invention has arisen to mitigate and/or obviate the afore-described disadvantages.

### SUMMARY OF THE INVENTION

The primary object of the present invention is to provide a false teeth positioning device which allows to attract the false teeth to the gums securely.

A false teeth positioning device in accordance with the present invention comprises:

a base including a concave surface to be attached onto the gums, the concave surface including a cavity formed thereon, and the base including a hole fixed on one side surface thereof to communicate with the cavity;

an attaching piece made of flexible materials and coupled to the concave surface of the base to cover the cavity, and including a plurality of indentions arranged on a bottom surface thereof to face toward the cavity, and including a number of flexible films formed on a top surface thereof to correspond to the indentions;

an axial seat secured to the one side of the base and including an axial bore disposed thereon to communicate with the cavity via the hole;

a shaft fixed to the axial bore of the axial seat, and including an O-shaped rubber ring arranged on an outer periphery of one end thereof proximate to the cavity;

a driving member driven from an exterior to actuate the shaft to move;

a stem, the axial seat including a sleeve portion and a support portion, the axial bore being disposed on the sleeve portion, one end of the sleeve portion being inserted to the hole of the base, the support portion including two movable recesses mounted on top and bottom ends thereof respectively, and each movable recess including an elongated slot mounted therein to communicate with the axial bore, the shaft including an aperture mounted on an outer periphery of another end thereof, the stem being inserted to the aperture and the elongated slot, and two ends of the stem being inserted to the two movable recesses.

### BRIEF DESCRIPTION OF THE DRAWINGS

FIG. 1 is a perspective view of the operation of a false teeth positioning device in accordance with a preferred embodiment of the present invention;

FIG. 2 is a perspective view of the exploded components of the false teeth positioning device in accordance with the preferred embodiment of the present invention;

FIG. 3 is a perspective view of the assembly of the false teeth positioning device in accordance with the preferred embodiment of the present invention;

FIG. 4 is a cross sectional view showing the operation of the false teeth positioning device in accordance with the preferred embodiment of the present invention;

FIG. 5 is another cross sectional view showing the operation of the false teeth positioning device in accordance with the preferred embodiment of the present invention;

FIG. 6 is a cross sectional showing the false teeth being not attached to the gums;

FIG. 7 is another cross sectional showing the false teeth being not attached to the gums.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

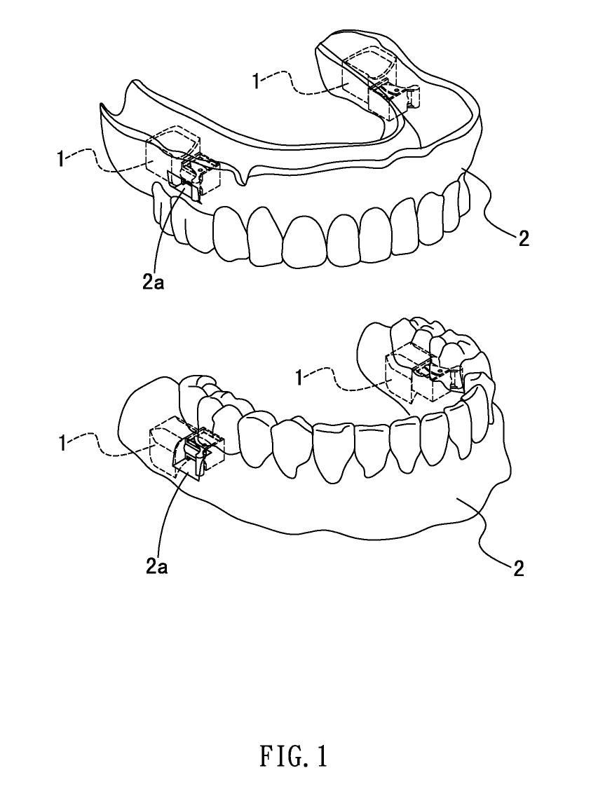

As shown in FIG. 1, a false teeth positioning device 1 according to a preferred embodiment of the present invention is embedded in false teeth 2 to attach the false teeth onto guns, and the false teeth 2 includes an orifice 2a disposed on one side thereof to manually control the false teeth positioning device 1 to generate an attracting force. A preferred position to embed the false teeth positioning device 1 is on a rear portion of each side of the false teeth 2.

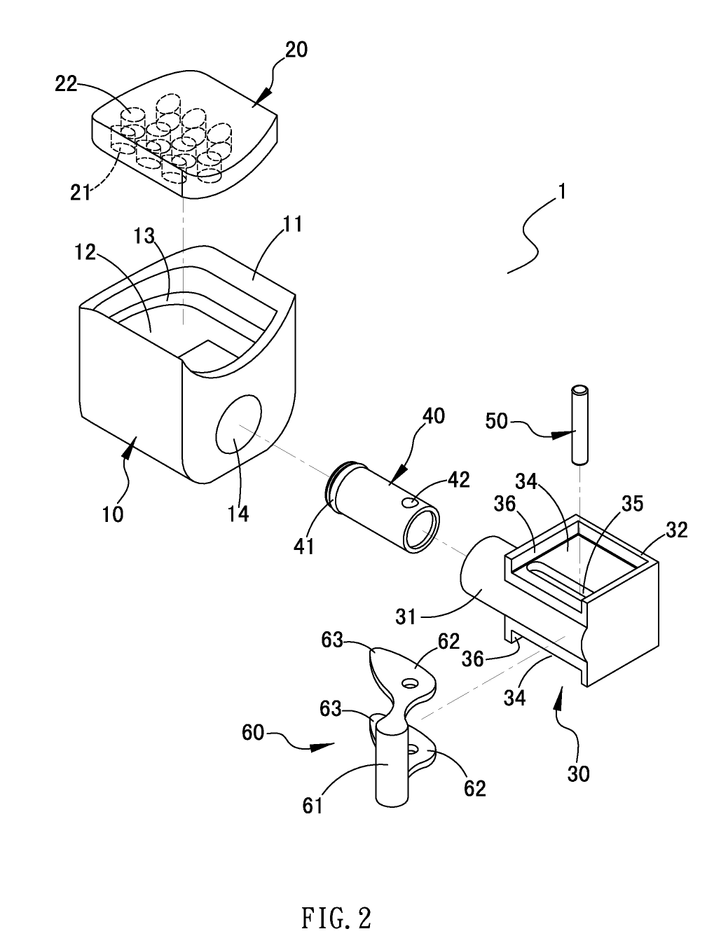

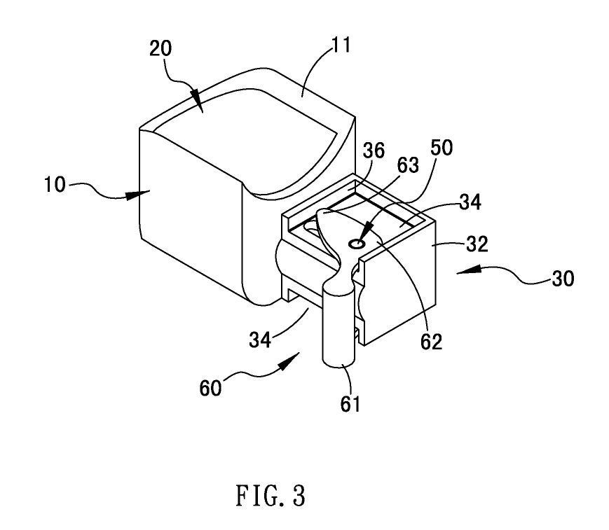

Referring to FIGS. 2-5, a false teeth positioning device 1 comprises a base 10, an attaching piece 20, an axial seat 30, a shaft 40, a stem 50, and a driving member 60, wherein

the base 10 is made of flexible materials, but a hardness of the flexible material is higher than that of the attaching piece 20, and includes a concave surface 11 to be attached onto the gums 3, the concave surface 11 includes a cavity 12 formed thereon to feed fluid 70, the fluid 70 is salt solution or other cleaners, and the cavity 12 includes a stepped rim 13 arranged around an inner wall thereof, the base 10 includes a hole 14 fixed on one side surface thereof to communicate with the cavity 12, and the cavity 12 can also be full of air.

The attaching piece 20 is made of flexible materials, such as silica gel, and a peripheral side thereof is embedded and fixed to the stepped rim 13 to cover the cavity 12, and a top surface thereof is formed to match with the concave surface 11 to be attached to the gums 3. The attaching piece 20 includes a plurality of indentions 21 arranged on a bottom surface thereof to face toward the cavity 12, and includes a number of flexible films 22 formed on the top surface thereof to correspond to the indentions 21.

The axial seat 30 includes a sleeve portion 31 and a support portion 32, one end of the sleeve portion 31 is inserted to the hole 14 of the base 10 and includes an axial bore 33 disposed thereon to communicate with the cavity 12 via the hole 14. The support portion 32 includes two movable recesses 34 mounted on top and bottom ends thereof respectively, and each movable recess 34 includes an elongated slot 35 mounted therein to communicate with the axial bore 33, and includes a stop fringe 36 fixed around an inner periphery thereof.

The shaft 40 is fixed to the axial bore 33 of the sleeve portion 31 of the axial seat 30, and includes an O-shaped rubber ring 41 arranged on an outer periphery of one end thereof proximate to the cavity 12, and includes an aperture 42 mounted on an outer periphery of another end thereof.

The stem 50 is inserted to the aperture 42 and the elongated slot 35, and two ends of the stem 50 insert to the two movable recesses 34.

The driving member 60 includes a pushing post 61 and two tabs 62 fixed on two ends of the pushing post 61, the pushing post 61 is located outside the axial seat 30 and moves in the orifice 2a of the false teeth 2, the tabs 62 insert to the movable recesses 34 and connect with the two ends of the stem 50 so that the pushing post 61 swings along the stem 50. The tab 62 includes a projected edge 63 to abut against the stop fringe 36.

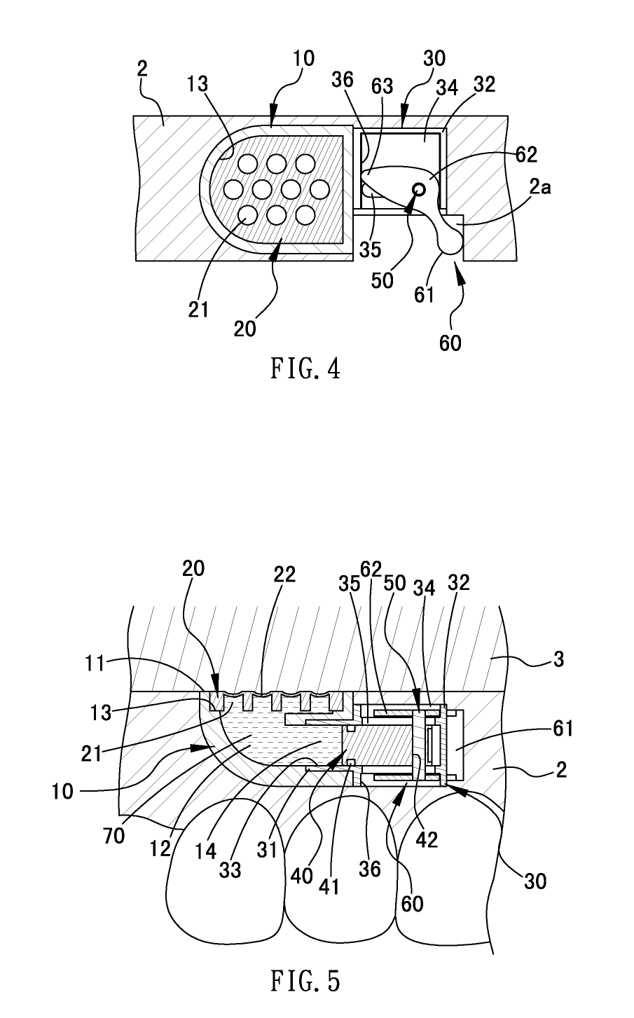

With reference to FIGS. 4 and 5, when the pushing post 61 of the driving member 60 is pushed by hand rightward from the orifice 2a of the false teeth 2, the pushing post 61 swings along the stem 50, and the projected edges 63 of the tabs 62 bias against the stop fringe 36 so that the stem 50 actuates the shaft 40 to leave away the cavity 12, and the fluid 70 in the cavity 12 is drawn to the axial bore 33, such that the fluid 70 makes the films 22 deform concavely, and outer surfaces of the films 22 generate vacuum attracting force to attract the gums 33 securely.

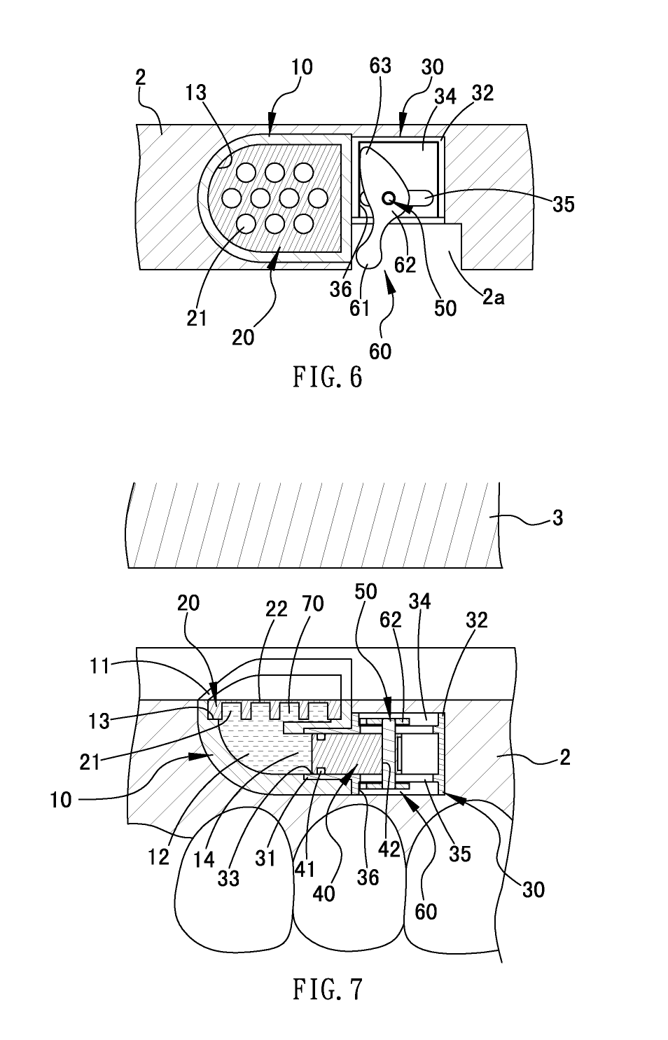

As illustrated in FIGS. 6 and 7, when the pushing post 61 of the driving member 60 is pushed leftward by hand from the orifice 2a of the false teeth 2, the pushing post 61 swings along the stem 50, and the projected edges 63 of the tabs 62 do not abut against the stop fringe 36 so that the shaft 40 is actuated by the stem 50 to move toward the cavity 12 to feed the fluid 70 in the axial bore 33 into the cavity 12, hence the fluid 70 makes the films 22 return original shapes to disengage the false teeth 2 from the gums.

While we have shown and described various embodiments in accordance with the present invention, it is clear to those skilled in the art that further embodiments may be made without departing from the scope of the present invention.

What is claimed is:

1. A false teeth positioning device being embedded in the false teeth to attach the false teeth onto guns and comprising:
a base including a concave surface to be attached onto the gums, the concave surface including a cavity formed thereon, and the base including a hole fixed on one side surface thereof to communicate with the cavity;
an attaching piece made of flexible materials and coupled to the concave surface of the base to cover the cavity, and including a plurality of indentions arranged on a bottom surface thereof to face toward the cavity, and including a number of flexible films formed on a top surface thereof to correspond to the indentions;
an axial seat secured to the one side of the base and including an axial bore disposed thereon to communicate with the cavity via the hole;
a shaft fixed to the axial bore of the axial seat, and including an O-shaped rubber ring arranged on an outer periphery of one end thereof proximate to the cavity;
a driving member driven from an exterior to actuate the shaft to move.

2. The false teeth positioning device as claimed in claim 1 further comprising a stem, the axial seat including a sleeve portion and a support portion, the axial bore being disposed on the sleeve portion, one end of the sleeve portion being inserted to the hole of the base, the support portion including two movable recesses mounted on top and bottom ends thereof respectively, and each movable recess including an elongated slot mounted therein to communicate with the axial bore, the shaft including an aperture mounted on an outer periphery of another end thereof, the stem being inserted to the aperture and the elongated slot, and two ends of the stem being inserted to the two movable recesses.

3. The false teeth positioning device as claimed in claim 2, wherein each movable recess includes a stop fringe fixed around an inner periphery thereof, the driving member including a pushing post and two tabs fixed on two ends of the pushing post, the pushing post is located outside the axial seat, the tabs insert to the movable recesses and connect with the two ends of the stem, the tab includes a projected edge to abut against the stop fringe, the pushing post swings along the stem, and the projected edges of the tabs bias against the stop fringe so that the stem actuates the shaft to leave away the cavity, and the fluid in the cavity is drawn to the axial bore.

4. The false teeth positioning device as claimed in claim 3, wherein the cavity includes a stepped rim arranged around an inner wall thereof, and a peripheral side of the attaching piece is embedded and fixed to the stepped rim to cover the cavity.

5. The false teeth positioning device as claimed in claim 3, wherein the base is made of flexible materials, but a hardness of the flexible material is higher than that of the attaching piece.

6. The false teeth positioning device as claimed in claim 5, wherein the attaching piece is made of silica gel.

7. The false teeth positioning device as claimed in claim 1, wherein the cavity is full of fluid.

8. The false teeth positioning device as claimed in claim 3, wherein the cavity is full of fluid.
